(19) United States
(12) Patent Application Publication
(10) Pub. No.: US 2018/0333684 A1
(43) Pub. Date: Nov. 22, 2018

(54) THE ONE-STEP PREPARATION PROCESS FOR THIN FILM COMPOSITE MEMBRANE USING A DUAL (DOUBLE LAYER)-SLOT COATING TECHNIQUE

(71) Applicant: KOREA UNIVERSITY RESEARCH AND BUSINESS FOUNDATION, Seoul (KR)

(72) Inventors: Jung-hyun LEE, Seoul (KR); Hyun Wook JUNG, Seoul (KR); Sung-Joon PARK, Seoul (KR); Won-gi AHN, Gyeongsan-si (KR); Wanseok CHOI, Yongin-si (KR); Yong Woo LEE, Seoul (KR)

(73) Assignee: KOREA UNIVERSITY RESEARCH AND BUSINESS FOUNDATION, Seoul (KR)

(21) Appl. No.: 15/768,431

(22) PCT Filed: Nov. 24, 2016
(86) PCT No.: PCT/KR2016/013636

§ 371 Date: Apr. 13, 2018

(30) Foreign Application Priority Data
Dec. 31, 2015 (KR) 10-2015-0190720

(51) Int. Cl. B01D 69/12; B01D 67/00; B01D 71/56; C02F 1/44; B05C 5/02

(52) U.S. Cl. CPC B01D 69/125; B01D 67/0006; B05C 5/0254; C02F 1/44; B01D 67/0095; B01D 71/56

(57) ABSTRACT

The present invention relates to a preparation process for a thin film composite (TFC) membrane (hereinafter TFC membrane), and provides a method for the preparation of a membrane through a one-step process using a dual (double layer)-slot coating technique. In the dual (double layer)-slot coating process according to the present invention, a TFC membrane can be prepared by: forming a double-solution layer through a one-step process of performing simultaneous applying/contact of two immiscible solutions, in which two kinds of reactive organic monomers are dissolved, on a porous support; and synthesizing a selective layer through a crosslinking reaction between the organic monomers at an interface of the double layer.

### TECHNICAL FIELD

The present invention relates to a process for the preparation of a thin film composite membrane (hereinafter, a TFC membrane), which is a key material in water treatment (wastewater treatment), desalination of sea water and a salinity gradient power generation processes.

The national research and development project supporting the present invention is a general research support project of the future creation science division, that is, Research Project No. 2015010143: The development of composite membranes using a support-free interfacial polymerization method, which is supported by the Korea University Industry-Academic Cooperation Foundation as a host organization. Further, the national research and development project supporting the present invention is the eco-smart water system development project of the Ministry of Environment, that is, Research Project No. 2016002100007: The development of technology of controlling contamination of membranes for advanced water treatment, which is supported by the Korea University Industry-Academic Cooperation Foundation as a host organization.

### BACKGROUND ART

The membranes used for water treatment and seawater desalination processes have been produced as a form of thin film composite (TFC) membrane where a thin selective layer is adhered onto a porous support.

The selective layer of the TFC membrane has been prepared by interfacial polymerization between two types of organic monomers dissolved in immiscible solvents on the porous support. For example, in the case of the commercialized reverse osmosis membrane, an amine monomer aqueous solution is brought into contact with an acyl chloride monomer solution in an organic solvent (mainly n-hexane) on a polysulfone support to form a crosslinked polyamide selective layer via a condensation reaction of two organic monomers at the interface.

The commercialized interfacial polymerization process for the preparation of the TFC membrane consists of two step processes. That is, the TFC membrane has been prepared through a two-step process including a first step of applying and impregnating a first organic monomer solution (mainly amine aqueous solution) on a porous support and a second step of applying a second organic monomer solution (mainly acyl chloride organic solution) to induce interfacial polymerization.

For example, Patent Document 1 (U.S. Pat. No. 4,277,344) is a source patent of a method including a general two-step process, in which a TFC membrane is prepared by synthesizing a polyamide selective layer on a support via interfacial polymerization. That is, an amine monomer aqueous solution is applied and impregnated on the porous support (first step), and then an acyl chloride organic solvent is applied thereon (second step) to synthesize a crosslinked polyamide selective layer.

However, the two-step preparation process not only causes an increase in the manufacturing facility cost but also results in an increase in the manufacturing cost of the membrane due to the increased manufacturing time, the complexity of the process and the use of a large amount of the solvent. Further, the relatively large amount of waste solvents and waste chemicals are discharged, increasing the risk of environmental pollution.

### DISCLOSURE

### Technical Problem

An object of the present invention is to provide a method that can continuously produce a membrane with a single (one-step) process by simultaneously applying and contacting two types of organic monomer solutions on a porous support using a dual (double layer)-slot coating technique.

### Technical Solution

The present invention provides a method for the preparation of a thin film composite membrane including simultaneously applying a first solution including a first organic monomer and a second solution including a second organic monomer on a porous support to form a double-solution layer; and forming a selective layer by interfacial polymerization between the first organic monomer and the second organic monomer.

### Advantageous Effects

In the present invention, the conventional two-step process for the preparation of the thin film composite membrane based on sequential contact of two organic monomer solutions on the support is performed in a single process. Accordingly, the manufacturing facility cost and process cost can be reduced, and the process time can be shortened, thereby reducing the manufacturing cost of the thin film composite membrane.

Further, a process for the preparation of the thin film composite membrane can be converted to an environmentally friendly process by minimizing the use of solvents and organic monomers and reducing the amount of chemical waste discharged.

Further, a high-performance thin film composite membrane can be prepared even on a support with which it is difficult to prepare a high-performance thin film composite membrane by the conventional fabrication technique. Moreover, it is expected that the fouling resistance can be improved by the unique structure of the prepared membrane. That is, the surface of the membrane prepared via the prior art has a rough ridge-and-valley structure, while the surface of the membrane prepared via the present invention is smooth and thus favorable for improving antifouling.

### DESCRIPTION OF DRAWINGS

FIG. 1 is a schematic view showing a conventional process for the preparation of a thin film composite membrane.

FIG. 2 is a schematic view showing a present invention for the preparation of a thin film composite membrane.

FIGS. 3 and 4 are simulation diagrams of a dual-slot die according to the present invention.

FIG. 5 is a graph showing the results of the performance stability of the thin film composite membrane prepared in the examples.

### BEST MODE OF THE INVENTION

The present invention relates to a method for the preparation of a thin film composite membrane including simultaneously applying a first solution including a first organic monomer and a second solution including a second organic monomer on a porous support to form a double-solution layer; and forming a selective layer by interfacial polymerization between the first organic monomer and the second organic monomer.

Hereinafter, a method for the preparation of a thin film composite membrane according to the present invention will be described in detail.

In the present invention, the porous support serves to support the selective layer and reinforce the mechanical strength of the thin film composite membrane. The type of the porous support is not particularly limited, and a porous support material used in a thin film composite membrane in the related field may be used without limitation. For example, as the porous support, polyacrylonitrile (PAN), polyvinylidene fluoride (PVDF), cellulose acetate, polyvinylpyrrolidone (PVP), polysulfone (PSF), polyethersulfone (PES), polyimide (PI), polyetherimide (PEI), polybenzoimidazole (PBI), polypropylene (PP), polyethylene (PE) or polytetrafluoroethylene (PTFE) may be used.

The pore size of the porous support may be in the range of 1 to 1000 nm, 10 to 100 nm, or 20 to 50 nm. The membrane performance is excellent in the above-described range.

In one embodiment, the porous support may be one in which the surface is not modified or the surface is modified by pretreatment, according to the type of the porous support. An example of the pretreatment includes oxidation treatment, acid or base treatment, hydrolytic treatment, UV/ozone treatment, plasma treatment or coating with a hydrophilic polymer. In the coating with a hydrophilic polymer, the hydrophilic polymer may be polydopamine, cellulose acetate or polyvinyl alcohol.

The oxidation treatment, hydrolytic treatment, UV/ozone treatment, plasma treatment or coating with a hydrophilic polymer may be carried out through general processes in the related field.

In the present invention, the first solution and the second solution may include immiscible or miscible solvents. In the present invention, immiscible solvents of the first solution and the second solution are used.

In the present invention, the first solution includes a first organic monomer and a first solvent, and the second solution includes a second organic monomer and a second solvent. The first solvent and the second solvent are immiscible each other, so that when the solution layer is formed, the solutions may form a double layer without being mixed with each other. Further, in the formed double layer, the first organic monomer and the second organic monomer may cause a crosslinking reaction upon contact.

In one embodiment, the type of the first organic monomer is not particularly limited, and for example, one or more selected from the group consisting of molecules with an amine or hydroxyl functional group, diethylene triamine (DETA), triethylene tetramine (TETA), diethyl propyl amine (DEPA), methane diamine (MDA), N-aminoethyl piperazine (N-AEP), m-xylenediamine (MXDA), isophoronediamine (IPDA), m-phenylenediamine (MPD), o-phenylenediamine (OPD), p-phenylenediamine (PPD), 4,4′-diaminodiphenyl methane (DDM), 4,4′-diaminodiphenyl sulphone (DDS), hydroquinone, resorcinol, catechol and hydroxylalkylamines, may be used.

In one embodiment, the type of the first solvent is not particularly limited, and for example, one or more selected from the group consisting of water, methanol, ethanol, propanol, butanol, isopropanol, ethyl acetate, acetone, hexane, pentane, cyclohexane, heptane, octane, carbon tetrachloride, benzene, toluene, xylene, tetrahydrofuran and chloroform may be used.

In one embodiment, the type of the second organic monomer is not particularly limited, and for example, one or more selected from the group consisting of molecules with acyl chloride functional groups, trimesoyl chloride (TMC), terephthaloyl chloride, cyclohexane-1,3,5-tricarbonyl chloride, 1-isocyanato-3,5-benzenedicarbonyl chloride and isophthaloyl chloride, may be used.

Further, in one embodiment, the type of the second solvent is not particularly limited, and for example, one or more selected from the group consisting of hexane, pentane, cyclohexane, heptane, octane, carbon tetrachloride, tetrahydrofuran, benzene, xylene and toluene may be used.

As described above, the method for the preparation of a thin film composite membrane according to the present invention includes simultaneously applying a first solution including a first organic monomer and a second solution including a second organic monomer on a porous support to form a double-solution layer; and forming a selective layer by interfacial polymerization between the first organic monomer and the second organic monomer.

In the conventional process for the preparation of a thin film composite membrane (hereinafter, referred to as a two-step preparation process or a two-step process), a selective layer is formed by sequentially applying two types of solutions onto a porous support. The membrane preparation is performed by a two-step preparation process, and thus manufacturing facility cost and manufacturing cost are high, and there is a problem of environmental pollution since large amounts of the organic monomer and solvent are used.

Further, in the second-step preparation process, since the first solution is applied to the porous support and then an excess amount of the first solution present on the surface of the support is removed, the selective layer to be formed upon application of the second solution may be formed at the surface or under the surface of the support.

In the present invention, a double-solution layer is formed through a single process (hereinafter, referred to as a one-step preparation process or a single process) in which two immiscible solutions are simultaneously applied and contacted on a porous support, the selective layer is synthesized through the cross-linking reaction between the organic monomers at the double layer interface, and thereby the thin film composite membrane having the selective layer adhered to the porous support may be prepared.

Accordingly, as compared to a case of the conventional preparation process including two steps of applying solutions, the manufacturing facility cost can be reduced, the process cost can be reduced by simplification of the process, and the process time can be shortened, and thus the manufacturing cost of the thin film composite membrane can be reduced. Further, since the use of solvents and organic monomers is minimized to reduce the discharge amount of chemical wastes, the method is environmentally friendly.

Further, the selective layer may be formed on the surface of the porous support, and then adhered to the support.

In one embodiment, simultaneous application of the first solution and the second solution may be performed through dual (double layer)-slot coating. The double-solution layer having a uniform thickness may be easily formed by the dual (double layer)-slot coating.

In one embodiment, the application thickness of the first solution may be in the range of 1 to 500 μm or 50 to 300 μm, and the application thickness of the second solution may be in the range of 1 to 500 μm or 50 to 300 μm.

In one embodiment, simultaneous application of the first solution and the second solution may be performed using a dual-slot die. The dual-slot die may simultaneously apply the first solution and the second solution on the porous support while allowing the porous support to move along a predetermined line.

The structure of the dual-slot die is not particularly limited as long as the dual-slot die can simultaneously apply the first solution and the second solution. For example, the dual-slot die may be separated into a first solution compartment and a second solution compartment through a mid-block, and slits for discharging the solution may be formed in each compartment.

In one embodiment, when a solution is applied using a dual-slot die (hereinafter, referred to as coating), it is important to ensure that the coating has a stable flow without swirling. To this end, the flow rate of the first and second solutions and the line movement speed of the dual-slot die may be appropriately adjusted under the coating process conditions.

For example, the flow rate per unit width of the first solution may be controlled to be in the range of 0.016×10⁻⁶ to 416.6×10⁻⁶ m²/s, 1×10⁻⁶ to 100×10⁻⁶ m²/s, 10×10⁻⁶ to 50×10⁻⁶ m²/s, or 15×10⁻⁶ to 20×10⁻⁶ m²/s, and the flow rate per unit width of the second solution may be controlled to be in the range of 0.016×10⁻⁶ to 416.6×10⁻⁶ m²/s, 1×10⁻⁶ to 100×10⁻⁶ m²/s, 10×10⁻⁶ to 50×10⁻⁶ m²/s, or 15×10⁻⁶ to 20×10⁻⁶ m²/s. Further, the line movement speed (line speed) of the dual-slot die may be controlled to be in the range of 1 to 50 m/min, 3 to 10 m/min, or 5 to 7 m/min.

Further, in one embodiment, the dimension of the dual-slot die may be adjusted so that the coating has a stable flow without swirling.

For example, the length of the mid-block may be in the range of 50 to 2000 μm, 200 to 800 μm, or 400 to 600 μm. The slit thickness of the first solution compartment may be in the range of 50 to 1500 μm, 100 to 500 μm, or 150 to 300 μm, and the slit thickness of the second solution compartment may be in the range of 50 to 1500 μm, 100 to 500 μm, or 150 to 300 μm. The length of the die lip as the exit portion of the slot die may be in the range of 50 to 2000 μm, 500 to 1000 μm, or 800 to 1300 μm.

Further, the length of a space (coating gap) between the dual-slot die and the porous support may be in a range of 20 to 1000 μm, 200 to 700 μm, or 350 to 600 μm.

In the present invention, the double-solution layer is formed by simultaneous application of the first solution and the second solution, and the solvents of the first solution and the second solution are not mixed with each other and exist as a double layer when the solutions are immiscible. Thereafter, an interfacial polymerization reaction occurs at the interface between the first solution and the second solution, and specifically, the first organic monomer and the second organic monomer may be cross-linked to synthesize a selective layer. Generally, although the first and second solutions are immiscible, the double layer and selective layer may be formed even when the first and second solutions are miscible, and thus the present invention is not limited to the case in which the first and second solutions are immiscible.

In the preparation method according to the present invention, the preparation of the membrane may be completed through a step of washing and drying the porous support on which the selective layer is formed, that is, the membrane to which the selective layer is adhered.

In one embodiment, the washing may be carried out using the same solvent as the solvent of the second solution or a solvent capable of being used as the second solvent, and the drying may be carried out at 30 to 80° C. or 40 to 60° C. for 1 to 60 minutes or 1 to 40 minutes.

The thin film composite membrane having the support and the selective layer bonded thereto may be finally prepared through the drying.

Further, the present invention relates to a thin film composite membrane prepared using the above-described preparation method.

The thin film composite membrane according to the present invention may have a sodium chloride (NaCl) rejection of 70% or more, 80% or more, 90% or more, or 95% or more.

The thin film composite membrane may be used as a water treatment membrane for seawater desalination, water and sewage treatment, wastewater treatment, water softening or the like, or may be used as a gas membrane for removal of carbon dioxide, removal of soot or filtering of a gas.

### MODE OF THE INVENTION

Hereinafter, the present invention will be described in detail with reference to the following examples. However, the following examples are illustrative of the present invention, and the contents of the present invention are not limited to the following examples.

### EXAMPLES

### 1. Materials

(a) PAN Porous Support

A polyacrylonitrile (PAN) support having a pore size of about 20 nm was used as the porous support. The support was hydrolyzed in a 2M NaOH aqueous solution at 40° C. for 90 minutes to enhance the hydrophilicity and negative charge of the surface of the support, which serves to enhance the adhesion between the formed selective layer and porous support.

(b) Organic Monomer and Solvent for Interfacial Polymerization

M-phenylenediamine (MPD) and water were used as the first organic monomer and the first solvent to dissolve the first organic monomer, respectively, and each of a 0.025, 0.05, 0.1 and a 2% MPD aqueous solution (first solution) was prepared.

Further, trimethoyl chloride (TMC) and hexane (n-hexane) were used as the second organic monomer and the second solvent to dissolve the second organic monomer, respectively, and a 0.1% TMC solution (second solution) was prepared.

### 2. Preparation of Thin Film Composite (TFC) Membranes

### (1) Comparative Example 1. Preparation of Thin Film Composite (TFC) Membranes Through Two-Step Preparation Process

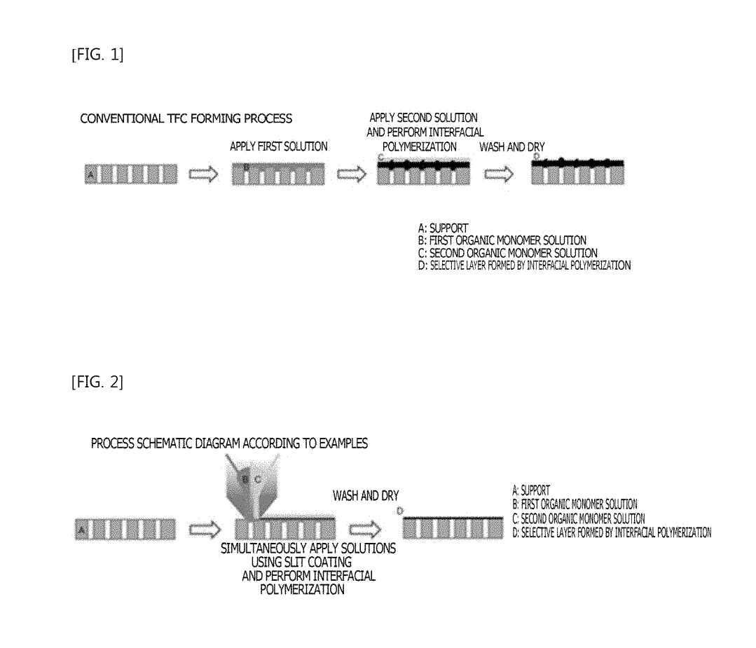

After the PAN support was fixed in a mold, the MPD aqueous solution (first solution) was poured thereon to impregnate the MPD aqueous solution into the support for about 3 minutes. The MPD aqueous solution was removed, and an excess amount of the MPD aqueous solution remaining on the surface of the support was removed. The TMC solution (second solution) was poured thereon to induce interfacial polymerization to form a selective layer. Thereafter, the surface of the membrane was washed with hexane, and then dried at 70° C. for about 5 minutes to prepare a thin film composite membrane (see FIG. 1).

### (2) Example 1. Preparation of Thin Film Composite (TFC) Membranes Through One-Step Preparation Process (Dual (Double Layer)-Slot Coating Technique)

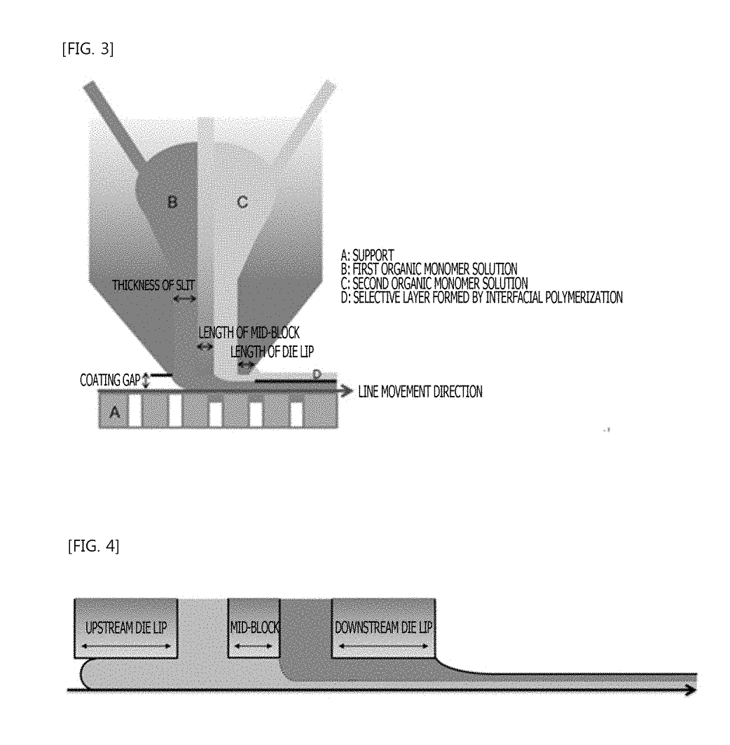

The PAN support was fixed on a line, and a thin film composite membrane was prepared using a dual-slot die. In the present invention, FIGS. 3 and 4 show the dimension of the dual-slot die.

After the MPD aqueous solution (first solution) and the TMC solution (second solution) were put into the dual-slot die, the flow rates of the MPD aqueous solution and the TMC solution were stabilized. After the stabilization of the flow rates, the two solutions were simultaneously spread onto the PAN support to form a double-solution layer, while the support moved at a constant speed along the line. Here, the selective layer was synthesized through interfacial polymerization in the double-solution layer. After the selective layer was prepared, the membrane was washed with hexane, and then dried at 50° C. for about 30 minutes to prepare a thin film composite membrane (see FIG. 2).

The slot coating was performed with the flow rates and line speed under stable flow conditions through the conditions of Table 1 so as to prevent swirling during coating.

TABLE 1
Operating parameters

| Name | Unit | | |
|---|---|---|---|
| Flow rate (*10⁻⁶) | m²/s | MPD aqueous | 17.54 |
| | | solution | |
| | | TMC hexane | 18.32 |
| | | solution | |
| Line speed | m/min | | 6 |

Further, the geometric parameters of the dual-slot die were adjusted on the basis of stable flow conditions through the conditions of the following Table 2 so as to prevent swirling.

TABLE 2
Geometric parameters

| Name | Unit | |
|---|---|---|
| Coating gap (H_{g}) | μm | 450 |
| Length of die lip (Lₛ) | μm | 1000 |
| Length of mid-block (L_{d}) | μm | 500 |
| Thickness of slit (Lₛ) | μm | 200 |

### 3. Experimental Example 1. Performance Test

The performance of the TFC membranes prepared by the method of Comparative Example 1 (two-step process) and the method of Example 1 (single step) using the same PAN support according to the concentration of a MPD aqueous solution (0.025, 0.05, 0.1 and 2%) were compared.

Specifically, a 2000 ppm NaCl aqueous solution was filtrated through the TFC membrane at room temperature (25° C.) and high pressure (15.5 bar) to measure water flux (water permeation rate) and a salt (NaCl) rejection using a cross-flow filtration equipment.

The water flux was calculated from the amount of water permeated per unit area of membrane and per unit time, and the NaCl rejection was calculated by measuring the salt concentrations of the feed and permeate solutions.

The results of the performance evaluation are shown in the following Table 3.

TABLE 3

| | Conventional interfacial | | | |
|---|---|---|---|---|
| Concentration | polymerization | | Dual-slot coating | |
| of MPD | technique (two- | | technique | |
| aqueous | step process) | | (single process) | |
| solution | Water flux | NaCL | Water flux | NaCL |
| (wt. %) | (Lm⁻²h⁻¹) | rejection (%) | (Lm⁻²h⁻¹) | rejection (%) |
| 2 | 8.3 ± 0.9 | 97.5 ± 1.5 | 8.1 ± 0.7 | 99.4 ± 0.3 |
| 0.1 | 6.9 ± 0.7 | 91.4 ± 1.3 | 13.0 ± 2.5 | 99.3 ± 0.6 |
| 0.05 | 2.7 ± 0.1 | 88.2 ± 1.8 | 25.3 ± 3.7 | 99.4 ± 0.6 |
| 0.025 | 4.5 ± 0.4 | 84.3 ± 6.1 | 31.8 ± 1.9 | 99.1 ± 0.6 |

In the case of the membrane prepared by the method of Comparative Example 1, the NaCl rejection did not exceed 98% at any MPD aqueous solution concentration, and thus it was impossible to use the membrane as a reverse osmosis membrane. This means that a defective selective layer was prepared.

On the other hand, in the case of the membrane prepared by the method of Example 1, the NaCl rejection was 99.1% or more at all MPD aqueous solution concentrations. It was confirmed that a defect-less, high-performance reverse osmosis membrane was prepared.

The structure and performance of the selective layer are highly dependent on the physical and chemical structure of the support. When a hydrophilic PAN support is used, the conventional membrane preparation process (two-step process) has a limitation in that it is difficult to prepare a highly dense selective layer having high separation performance. Also, low water flux and NaCl rejection are observed at low concentration conditions of the MPD aqueous solution.

On the other hand, in the case of the preparation process according to the present invention, it is possible to prepare a highly dense selective layer having high separation performance regardless of the type and structure of the support, provided that the adhesion between the selective layer and the support is sufficient. In addition, as the concentration of MPD aqueous solution is lowered, the water flux increases and the NaCl rejection is also excellent. Thus, it is possible to develop a reverse osmosis membrane having high water flux.

### 4. Experimental Example 2. Measurement of Surface and Cross-Sectional Structures

The structure of the TFC membrane prepared by the methods of Comparative Example 1 and Example 1 in a case in which a 2% MPD aqueous solution was used was measured.

The surface structure of the TFC membrane was characterized through SEM and AFM images, and the cross-sectional structure of the TFC membrane was characterized through a TEM image.

The results of the measurement are shown in the following Table 4.

As shown in Table 4, it was confirmed that the TFC membrane prepared by the method of Example 1 had a very low surface roughness as compared with Comparative Example 1. Accordingly, it is expected that the TFC membrane according to the present invention can reduce the membrane fouling which may occur during the membrane operating process.

Further, when the cross-sectional structures was compared, the TFC membrane prepared by the method of Example 1 was thinner in thickness and higher in density than Comparative Example 1. That is, the membrane according to the present invention is expected to have relatively high separation performance as compared with Comparative Example 1.

Further, the surface structure of the TFC membrane prepared by the method of Example 1 according to the concentration of the MPD aqueous solution (0.025, 0.05, 0.1 and 2%) was measured through a SEM image.

Further, the thickness of the selective layer was measured. Here, the thickness of the selective layer was measured in the same manner as in Example 1 except that a silicon wafer was used in place of the PAN support. The thickness was measured using an AFM.

The results of the measurement are shown in the following Table 5.

In the case of the TFC membrane prepared using the preparation method according to the present invention, the thickness of the selective layer may be measured by a method using a silicon wafer and an AFM which is simpler than the conventional thickness measurement method using a TEM.

As shown in Table 5, in the TFC membrane prepared by the method of Example 1, the lower the concentration of the MPD aqueous solution, the smaller the surface roughness and the thinner the thickness of the selective layer. As a result, a TFC membrane having increased water flux is prepared.

The preparation method of the present invention has an advantage that it is possible to systematically analyze the structure-property-performance of the thin film composite membrane.

### 5. Experimental Example 3. Stability Evaluation

The stability of the TFC membrane prepared by the method of Example 1 in a case in which a 2% MPD aqueous solution was used was evaluated.

The stability was determined by measuring water flux and a NaCl rejection for 7 days.

The water flux and the NaCl rejection were measured in the same manner as in Experimental Example 1.

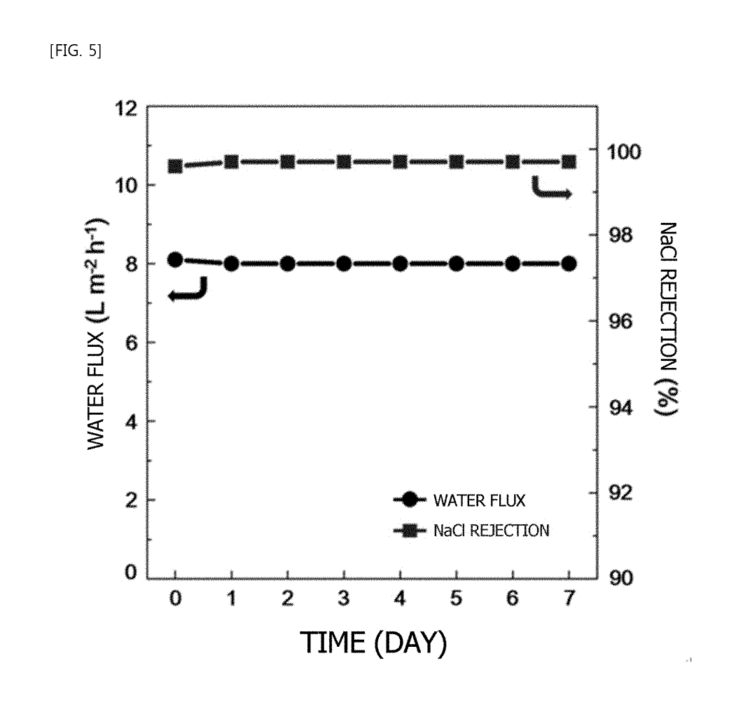

The results are shown in FIG. 5.

As shown in FIG. 5, it was confirmed that the membrane prepared by the method of Example 1 stably maintained performance without structural defects even under long-term performance measurement conditions.

### INDUSTRIAL AVAILABILITY

In the present invention, the conventional two-step process for the preparation of the thin film composite membrane by sequentially applying and contacting two types of organic monomer solutions on the support is performed in a single process. Accordingly, the manufacturing facility cost and process cost can be reduced, and the process time can be shortened, thereby reducing the manufacturing cost of the thin film composite membrane.

The thin film composite membrane according to the present invention can be used as a water treatment membrane for seawater desalination, water and sewage treatment, wastewater treatment, water softening or the like, or can be used as a gas membrane for removal of carbon dioxide, removal of soot or filtering of a gas.

1. A method for the preparation of a thin film composite membrane, comprising:
simultaneously applying a first solution including a first organic monomer and a second solution including a second organic monomer on a porous support to form a double-solution layer; and
forming a selective layer by interfacial polymerization between the first organic monomer and the second organic monomer.

2. The method according to claim 1, wherein the porous support is polyacrylonitrile (PAN), polyvinylidene fluoride (PVDF), cellulose acetate, polyvinylpyrrolidone (PVP), polysulfone (PSF), polyethersulfone (PES), polyimide (PI), polyetherimide (PEI), polybenzoimidazole (PBI), polypropylene (PP), polyethylene (PE) or polytetrafluoroethylene (PTFE).

3. The method according to claim 1, wherein the porous support has a pore size in a range of 1 to 1000 nm.

4. The method according to claim 1, wherein a surface of the porous support is unmodified, or modified by oxidation treatment, acid or base treatment, hydrolytic treatment, UV/ozone treatment, plasma treatment or coating with a hydrophilic polymer.

5. The method according to claim 4, wherein, in the coating with a hydrophilic polymer, the hydrophilic polymer is polydopamine, cellulose acetate or polyvinyl alcohol.

6. The method according to claim 1, wherein the first solution and the second solution are immiscible or miscible.

7. The method according to claim 1, wherein the first organic monomer is one or more selected from the group consisting of molecules with an amine or hydroxyl functional group, diethylene triamine (DETA), triethylene tetramine (TETA), diethyl propyl amine (DEPA), methane diamine (MDA), N-aminoethyl piperazine (N-AEP), m-xylenediamine (MXDA), isophoronediamine (IPDA), m-phenylenediamine (MPD), o-phenylenediamine (OPD), p-phenylenediamine (PPD), 4,4′-diaminodiphenyl methane (DDM), 4,4′-diaminodiphenyl sulphone (DDS), hydroquinone, resorcinol, catechol and hydroxylalkylamines.

8. The method according to claim 1, wherein a solvent of the first solution is one or more selected from the group consisting of water, methanol, ethanol, propanol, butanol, isopropanol, ethyl acetate, acetone, hexane, pentane, cyclohexane, heptane, octane, carbon tetrachloride, benzene, toluene, xylene, tetrahydrofuran and chloroform.

9. The method according to claim 1, wherein the second organic monomer is one or more selected from the group consisting of molecules with acyl chloride functional groups, trimesoyl chloride (TMC), terephthaloyl chloride, cyclohexane-1,3,5-tricarbonyl chloride, 1-isocyanato-3,5-benzenedicarbonyl chloride and isophthaloyl chloride.

10. The method according to claim 1, wherein a solvent of the second solution is one or more selected from the group consisting of hexane, pentane, cyclohexane, heptane, octane, carbon tetrachloride, tetrahydrofuran, benzene, xylene and toluene.

11. The method according to claim 1, wherein simultaneous application of the first solution and the second solution is performed through dual (double layer)-slot coating.

12. The method according to claim 1, wherein each of application thicknesses of the first solution and the second solution is in a range of 1 to 500 μm.

13. The method according to claim 1, wherein simultaneous spreading of the first solution and the second solution is performed using a dual-slot die, and the dual-slot die is separated into a first solution compartment and a second solution compartment through a mid-block, and slits for discharging the solution are formed in each compartment.

14. The method according to claim 13, wherein each of the first solution and the second solution has a flow rate per unit width of 0.016×10⁻⁶ to 416.6×10⁻⁶ m²/s.

15. The method according to claim 13, wherein the dual-slot die has a line movement speed of 1 to 50 m/min.

16. The method according to claim 13, wherein a length of a mid-block of the dual-slot die is in a range of 50 to 2000 μm,
a slit thickness of the first solution compartment is in a range of 50 to 1500 μm, and a slit thickness of a second solution compartment is in a range of 50 to 1500 μm,
a length of a die lip is in a range of 50 to 2000 μm, and
a length of a space (coating gap) between the dual-slot die and the porous support is in a range of 20 to 1000 μm.

17. The method according to claim 1, further comprising washing and drying the porous support on which the selective layer is formed.
